(19) United States
(12) Patent Application Publication
(10) Pub. No.: US 2006/0129999 A1
(43) Pub. Date: Jun. 15, 2006

(54) Methods and apparatus for using bookmarks in a trace buffer

(75) Inventors: Daisuke Hiraoka, Kanagawa (JP); Masaki Osawa, Austin, TX (US)

Correspondence Address: KAPLAN GILMAN GIBSON & DERNIER L.L.P., 900 ROUTE 9 NORTH, WOODBRIDGE, NJ, 07095, US

(73) Assignee: Sony Computer Entertainment Inc.

(21) Appl. No.: 10/989,750

(22) Filed: Nov. 16, 2004

(51) Int. Cl. G06F 9/44

(52) U.S. Cl. 717/128

(57) ABSTRACT

Methods and apparatus provide for: producing trace data from program status data received from at least one processor, the at least one processor being operable to execute software by addressing instructions in accordance with addresses obtained from a program counter; and storing the trace data in a trace buffer, wherein the trace data includes: (i) aggregate counts of respective program execution events; (ii) the addresses obtained from the program counter at various times; and (iii) bookmark data containing program performance information that includes neither the aggregate counts nor the addresses.

### BACKGROUND OF THE INVENTION

The present invention relates to methods and apparatus for enabling the insertion of any type of processor information (e.g., processor and/or software performance information) to be included in a trace buffer.

In recent years, there has been an insatiable desire for faster computer processing data throughputs because cutting-edge computer applications are becoming more and more complex, and are placing ever increasing demands on processing systems. Graphics applications are among those that place the highest demands on a processing system because they require such vast numbers of data accesses, data computations, and data manipulations in relatively short periods of time to achieve desirable visual results. Real-time, multimedia applications also place a high demand on processing systems; indeed, they require extremely fast processing speeds, such as many thousands of megabits of data per second. While some processing systems employ a single processor to achieve fast processing speeds, others are implemented utilizing multi-processor architectures. In multi-processor systems, a plurality of sub-processors can operate in parallel (or at least in concert) to achieve desired processing results.

It is difficult, however, to obtain processor performance and/or software performance data from state of the art processing systems, particularly multi-processor systems. Some details of an approach to obtaining performance data from a processing system may be found in U.S. patent application Ser. No.: 10/881,971, filed Jun. 30, 2004, the entire disclosure of which is hereby incorporated by reference.

Prior art approaches to obtaining processor performance and software performance data involve monitoring the signaling on numerous signal pins on a semiconductor package in which the processor is disposed. Typically, there are about 10-20 such pins carrying such signals as cache misses, data loads, branch occurrences and address information (address trace). While this approach is practical for many processor chips, it is not practical for state of the art processors having ultra-high speed interfaces, extremely high processing speeds, etc. Indeed, the data appear too rapidly and the quantity of data is too high to extract over dedicated pins. Although the number of pins could be increased to accommodate higher data rates and data quantity, there is a substantial cost associated with having many external pins used only for evaluation purposes.

Accordingly, there are needs in the art for new methods and apparatus for obtaining processor and software performance information in high speed processors, such as multi-processor systems. It would also be desirable to obtain other types of performance information (beyond the prior art cache misses, data loads, branch occurrences and address information) that may be used to improve the evaluation process.

### SUMMARY OF THE INVENTION

Aspects of the invention are directed to methods and apparatus for enabling the insertion of any type of processor information (e.g., processor and/or software performance information) to be included in a trace buffer located on-chip or off-chip with respect to the processor.

Aspects of the present invention employ a number of on-chip counters to accumulate occurrences of such signals as cache misses, data loads, branch occurrences, branch miss stall, DMA stalls etc. The counts are stored on an on-chip or off-chip trace buffer for later download and evaluation. A number of multiplexers may be disposed between the counters and the signals such that a single counter may be used for different signals. Further, a bookmark register may receive virtually any data (such as a thread number) from the processor for delivery to the trace buffer. The thread number may be used to provide an indication of “where the program was” when certain of the data stored in the trace buffer was obtained and stored. Thereafter, the processor information including the bookmark data may be read from the trace buffer for analysis.

In accordance with one or more aspects of the present invention, methods and apparatus provide for: producing trace data from program status data received from at least one processor, the at least one processor being operable to execute software by addressing instructions in accordance with addresses obtained from a program counter; and storing the trace data in a trace buffer, wherein the trace data includes: (i) aggregate counts of respective program execution events; (ii) the addresses obtained from the program counter at various times; and (iii) bookmark data containing program performance information that includes neither the aggregate counts nor the addresses.

In accordance with one or more aspects of the present invention, an apparatus includes: a plurality of processors, each operable to execute software by addressing instructions in accordance with addresses obtained from a first program counter; a main processing unit operable to execute software by addressing instructions in accordance with addresses obtained from a second program counter; and a performance monitor circuit operable to produce and store trace data from program status data received from the processors, the trace data including: (i) aggregate counts of respective program execution events; (ii) the addresses obtained from at least one of the first and second program counters at various times; and (iii) bookmark data containing program performance information that includes neither the aggregate counts nor the addresses, wherein the main processing unit is further operable to execute a supervisory software program that causes at least one of the aggregate counts, the addresses, and the bookmark data to be introduced into the trace data when one or more conditions are met.

In accordance with one or more aspects of the present invention, a performance monitor includes: a formatting circuit operable to produce trace data from program status data received from at least one processor, the at least one processor being operable to execute software by addressing instructions in accordance with addresses obtained from a program counter; a trace buffer operable to store the trace data; and a controller operable to manage the writing of the trace data into the trace buffer and the reading of the trace data out of the trace buffer, wherein the trace data includes: (i) aggregate counts of respective program execution events; (ii) the addresses obtained from the program counter at various times; and (iii) bookmark data containing program performance information that includes neither the aggregate counts nor the addresses.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram illustrating the structure of a multi-processing system having two or more sub-processors and a performance monitor in accordance with one or more aspects of the present invention;

FIG. 2 is a more detailed block diagram of the multi-processing system of FIG. 1 in accordance with one or more further aspects of the present invention;

FIG. 3 is a block diagram of an alternative configuration of a portion of the performance monitor of the processing system of FIG. 1 in accordance with one or more further aspects of the present invention;

FIG. 4 is a conceptual diagram of a data formatting structure for packing program data for storage in a buffer of the performance monitor of the processing system of FIG. 1 in accordance with one or more further aspects of the present invention;

FIG. 5 is a conceptual diagram of an alternative data formatting structure for packing program data for storage in a buffer of the performance monitor in accordance with one or more further aspects of the present invention;

FIG. 6 is a conceptual diagram of a further alternative data formatting structure for packing program data for storage in a buffer of the performance monitor in accordance with one or more further aspects of the present invention;

FIG. 7 is a conceptual diagram of a further alternative data formatting structure for packing program data for storage in a buffer of the performance monitor in accordance with one or more further aspects of the present invention;

FIG. 8 is a conceptual diagram of a further alternative data formatting structure for packing program data for storage in a buffer of the performance monitor in accordance with one or more further aspects of the present invention;

FIG. 9 is a conceptual diagram illustrating an example of trace data that may be stored in a buffer of the performance monitor in accordance with one or more further aspects of the present invention;

FIG. 10 is a block diagram illustrating an example implementation of the performance monitor of FIG. 1 in accordance with one or more further aspects of the present invention;

FIG. 11 is a block diagram illustrating the structure of an alternative multi-processing system in accordance with one or more aspects of the present invention;

FIG. 12 is a diagram illustrating a preferred processor element (PE) that may be used to implement a multi-processor system in accordance with one or more further aspects of the present invention;

FIG. 13 is a diagram illustrating the structure of an exemplary sub-processing unit (SPU) of the system of FIG. 12 in accordance with one or more further aspects of the present invention.

FIG. 14 is a diagram illustrating the structure of a processing unit (PU) of the system of FIG. 12 in accordance with one or more further aspects of the present invention.

### DETAILED DESCRIPTION OF THE PRESENT INVENTION

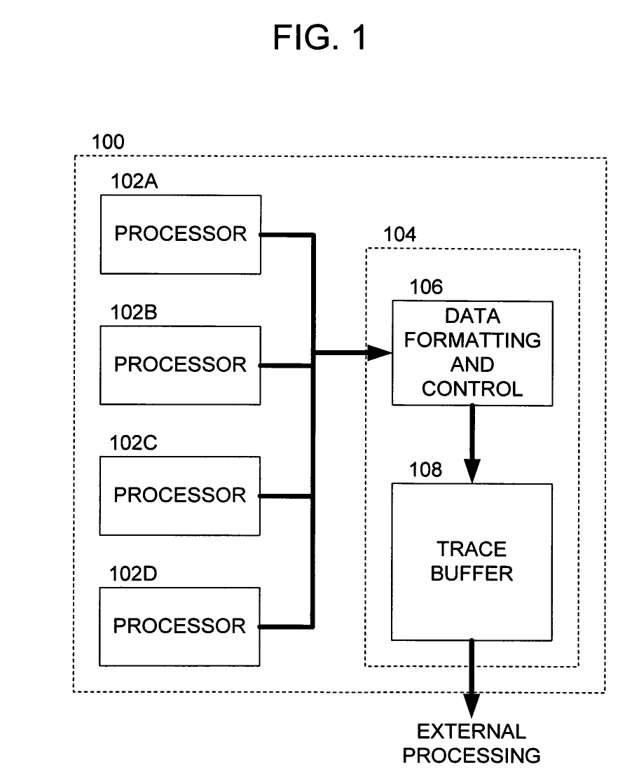

With reference to the drawings, wherein like numerals indicate like elements, there is shown in FIG. 1 a multi-processing system 100 suitable for employing one or more aspects of the present invention. For the purposes of brevity and clarity, the block diagram of FIG. 1 will be referred to and described herein as illustrating an apparatus 100, it being understood, however, that the description may readily be applied to various aspects of a method with equal force. The processing system 100 preferably includes a plurality of processors 102A-D and a performance monitor 104 interconnected by way of one or more lines, which may be a bus arrangement, dedicated signal lines and/or a combination of both.

The processors 102A-D preferably operate in parallel (or at least in concert) to achieve desired processing results. Although four processors 102 are illustrated by way of example, any number may be utilized without departing from the spirit and scope of the present invention. The processors 102A-D may be implemented by way of similar construction or of differing construction. For example, the processors 102 may be implemented using any of the known microprocessors that are capable of executing software and/or firmware, including standard microprocessors, distributed microprocessors, etc. By way of example, the processors 102 may be graphics processors that are capable of requesting and manipulating data, such as pixel data, including gray scale information, color information, texture data, polygonal information, video frame information, etc.

In accordance with one or more embodiments of the present invention, one of the processors 102 preferably takes on the roll of a main processor, such as processor 102A. The main processor 102A, for example, may monitor the application programs and data being executed on the other processors 102 in order for the main processor 102A to invoke processing changes. These processing changes may include moving tasks from one processor 102 to another processor 102, to allocate data among the processors 102, etc.

The main processor 102A is also preferably operable to execute a supervisory program that operates in concert with the performance monitor 104 such that trace data are produced and stored. In alternative embodiments of the invention, an application program may operate with the performance monitor circuit 104 to track performance data. As shown, the performance monitor 104 includes a formatting and control circuit 106 and a trace buffer 108. The formatting and control circuit 106 is preferably operable to produce the trace data from program status data received from the processors 102 and store same in the trace buffer 108. The trace data may include aggregate counts of respective program execution events, such as cache miss events, execution of particular software instructions (such as a load instruction), and program stalls (such as a branch miss stall, a direct memory access stall, etc.). The trace data may also include program addresses obtained from the program counters of the processors at various times during program execution. Still further, the trace data may include bookmark data containing program performance information, for example, program thread IDs, frame IDs (e.g., for graphics processing), or any other program information other than the aggregate counts and the program addresses.

Preferably, the formatting and control circuit 106 produces the trace data and causes same to be stored in the trace buffer 108 at regular time intervals, although as will be discussed hereinbelow the bookmark data may be produced and stored at irregular time intervals depending on the event triggering the production of the bookmark data. When a sufficient quantity of trace data are stored in the trace buffer 108, such data may be read out of the trace buffer 108 (e.g., through a data port or the like) for external processing. Such external processing may include sorting through the trace data to determine how well or poorly the processing system 100 performed when executing one or more software programs. Advantageously, such analysis may take place based on the program execution events, the program addresses, and the bookmark data, which may enable a determination of “where the program was” when certain events occurred during program execution. This can greatly improve the analysis process and lead to a better understanding of the processing performance of the processing system 100.

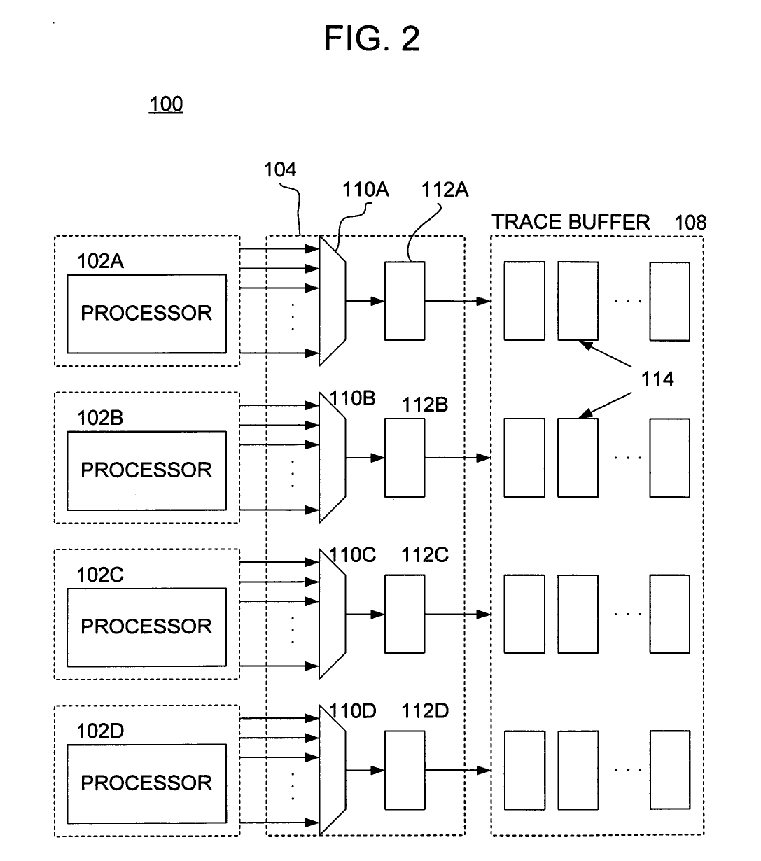

Reference is now made to FIG. 2, which is a more detailed block diagram of the multi-processing system 100 of FIG. 1. The data formatting and control circuit 106 preferably includes one or more multiplexers 110A-D and one or more digital counters 112A-D. The multiplexers 110A-D are operable to receive signals from the respective processors 102A-D, where such signals are indicative of the occurrences of the program execution events. For example, the signals entering the multiplexer 110A may represent occurrences of cache misses, load instruction executions, branch miss stalls, branch address taken events, DMA stalls, etc., respectively. Similarly, the other multiplexers 110B-D receive such signals from the other processors 102B-D. Although the above events have been provided for purpose of discussion, it is understood that any event/condition of one of the processors 102, bus system(s), I/O interfaces, memory interfaces, memory access controllers (such as a direct memory access controller), etc. of the system 100 may be input to the data formatting and control circuit 106. As is well known in the art of signal multiplexing, the multiplexers 110A-D may be controlled to output a signal that represents each of the input signals at a particular time.

The respective outputs from the multiplexers 110A-D are input into the respective digital counters 112A-D, which increment each time a particular program execution event occurs. Thus, at the end of a particular time interval, the value from the respective counters 112A-D may be stored in the trace buffer 108 for later analysis. By way of example, the respective counters 112A-D may be 8-bit counters that are operable to provide a maximum of 255 counts. Accordingly, a suitable time interval during which to count program execution events may be on the order of about 200 processor cycles, where each cycle may be occurring at rate of about 4 GHz. It is noted, however, that the counters 112 may be implemented utilizing 16-bit or higher capacity as may be dictated by the particular application.

It is noted that the use of one multiplexer 110 and one counter 112 for each processor 102 is illustrated for discussion purposes only. Indeed, any number of multiplexers 110 and/or counters 112 may be employed without departing from the spirit and scope of the present invention. In a preferred embodiment, there is a 64-to-1 multiplexer 110 for each counter 112 such that two 64-bit signal groups may be taken from each island. Any number of counters of any size may be employed.

The trace data stored in the trace buffer 108 may be organized into groups or blocks 114, where each block represents the data obtained during a particular time interval. Alternatively, the blocks of data 114 may represent respective types of trace data, such as cache misses, load instruction executions, etc., it being understood that the particular organization of the data within the trace buffer 108 may be readily adjusted based on the particular application.

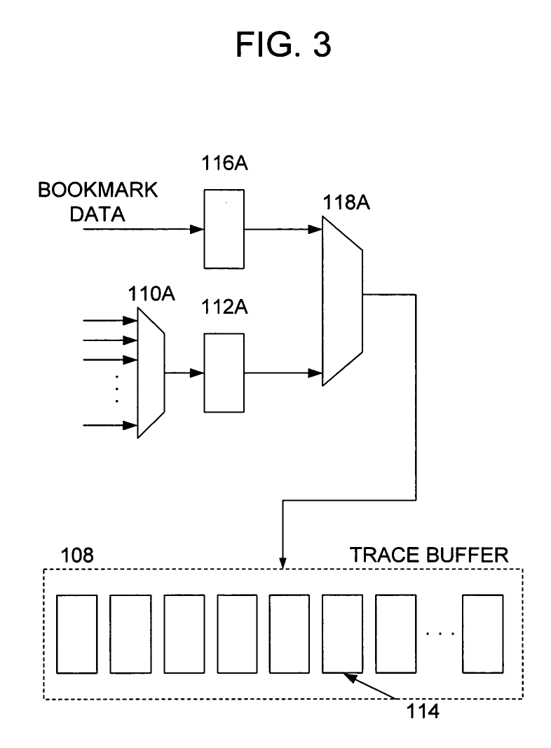

With reference to FIG. 3, which is a block diagram of an alternative configuration of the data formatting and control circuit 106, bookmark data may also be introduced into the trace data and stored in the trace buffer 108. Conceptually, the bookmark data may be introduced by way of a special purpose register 116A, which receives the bookmark data whenever a particular event occurs that justifies the introduction of such data. For example, thread IDs may be introduced into the trace data by writing the thread IDs into the special purpose register 116A and then multiplexing such data along with the aggregate counts by way of a further multiplexer 118A. It is noted that the special purpose register 116A may be disposed within the performance monitor 104 or it may be disposed within one or more of the processors 102A-D.

In a preferred embodiment, the processor 102A takes on the role of a main processor and includes the special purpose register 116A therein. The supervisor program running on the main processor 102A preferably causes the bookmark data to be written to the special purpose register 116A when one or more conditions are met. While the particular conditions that may cause the supervisor program to initiate bookmark data into the special purpose register 116A are numerous, examples of such conditions are the start (or the end) of each program thread, the start or end of a given frame in a graphics process, etc.

In addition to the aggregate counts and the bookmark data, the program addresses obtained from the program counters of the processors 102 are also preferably included among the trace data and stored in the trace buffer 108. The program addresses of the processors 102 are preferably captured and introduced into the trace data upon a particular condition. For example, if a processor 102 is acting as a main processor, then the condition triggering a program address capture may be the execution of a particular type of program instruction, such as a branch instruction. In accordance with certain assembly language program instruction sets, these branch instructions may include bclr(l) w/taken, bcctr(l) w/taken, and/or rfid event.

In contrast to the address capturing event associated with the main processor 102A, the address capturing event associated with the other processors 102B may be the passage of a particular interval of time. For example, the address capturing event may be multiples of 16 processing cycles. Assuming that the interval associated with the aggregate counts of the program execution events occurs on the order of 200 processing cycles, it is apparent that the rate at which the program addresses of the other processors 102B-D may be significantly high. In comparison to the frequency at which the aggregate counts and the addresses obtained from the program counters of the processors 102 are introduced into the trace data, the bookmark data will likely be introduced at a much lower frequency, particularly when the bookmark data are thread IDs.

In accordance with an example embodiment of the invention, it is assumed that the length of the addresses associated with the processors 102B-D is smaller than the length of the addresses associated with the main processor 102A. This may occur when the address space accessible by the processors 102B-D is smaller than the address space accessible by the main processor 102A.

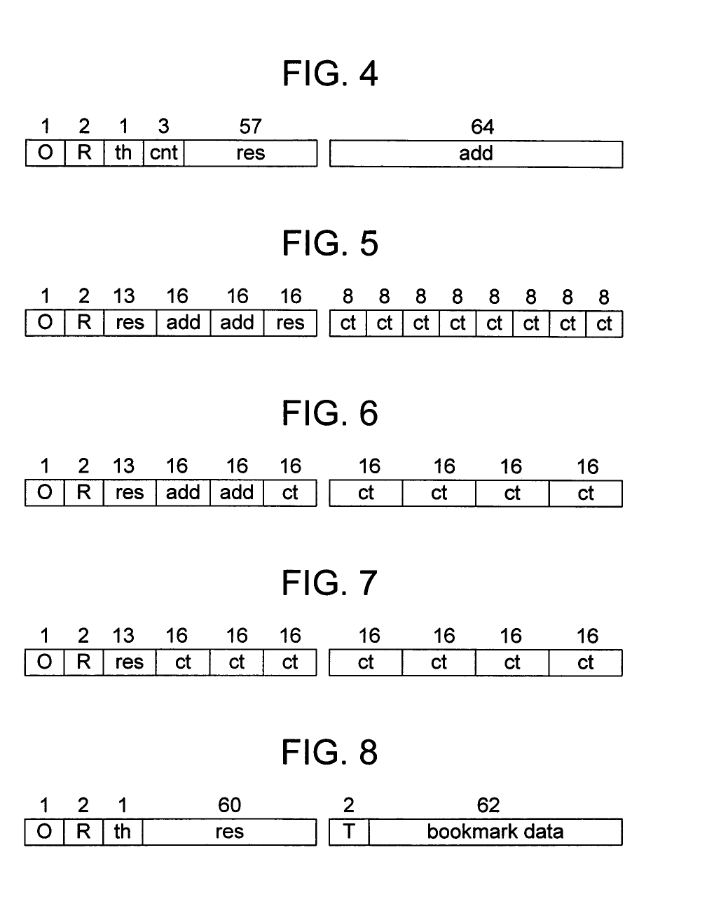

With reference to FIG. 4, the performance monitor 104, specifically, the data formatting and control circuit 106, is preferably operable to pack the trace data into respective strings of N bits in length and to store same in the trace buffer 108. In a preferred embodiment, the strings are 128 bits in length, although those skilled in the art will appreciate that any length strings may be employed without departing from the spirit and scope of the present invention. The first bit of the string, labeled O, indicates an overflow condition. The next 2 bits of the string, labeled R, indicate the record type. The next bit of the string, labeled th, is a programmable bit that turns on or off the capturing event based on the value of the bit. The next three bits of the string, labeled cnt, may be used to represent the capture event. The next 57 bits of the string, labeled res, are reserved. The program address taken from the program counter of the main processor 102A are stored in the remaining 64 bits of the string.

With reference to FIG. 5, the 16 bit program addresses captured from the program counters of the other processors 102B-D may be stored in the 16-bit locations labeled add. Also shown in FIG. 5 are a number of 8-bit locations labeled ct, which may be used to store the aggregate counts of the program execution events, assuming that the size of the respective counters 112 is 8 bits. With reference to FIG. 6, 16-bit program addresses and 16-bit aggregate counts may be packed into the respective strings for storage in the trace buffer 108. Still further, as illustrated in FIG. 7, a particular string may contain only aggregate counts, such as 8-bit or 16-bit in length. With reference to FIG. 8, the bookmark data may be up to 62 bits in length, where the 2-bit segment labeled T may be used to indicate the start/stop recording trigger for the bookmark data.

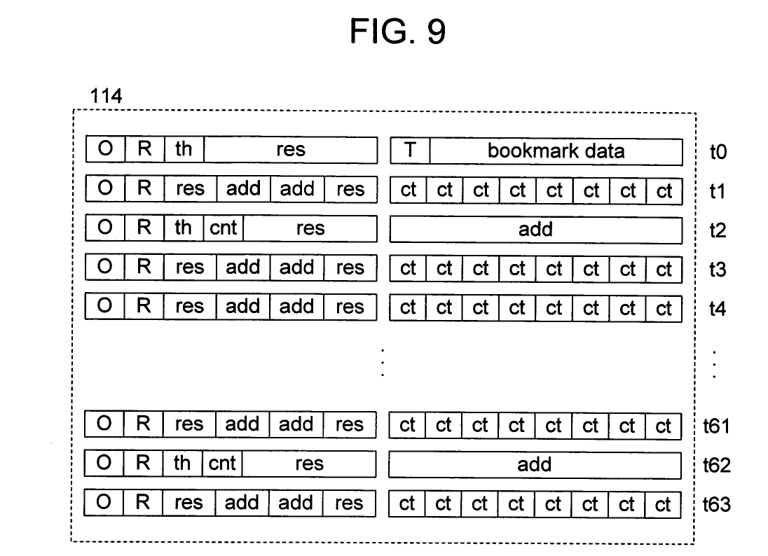

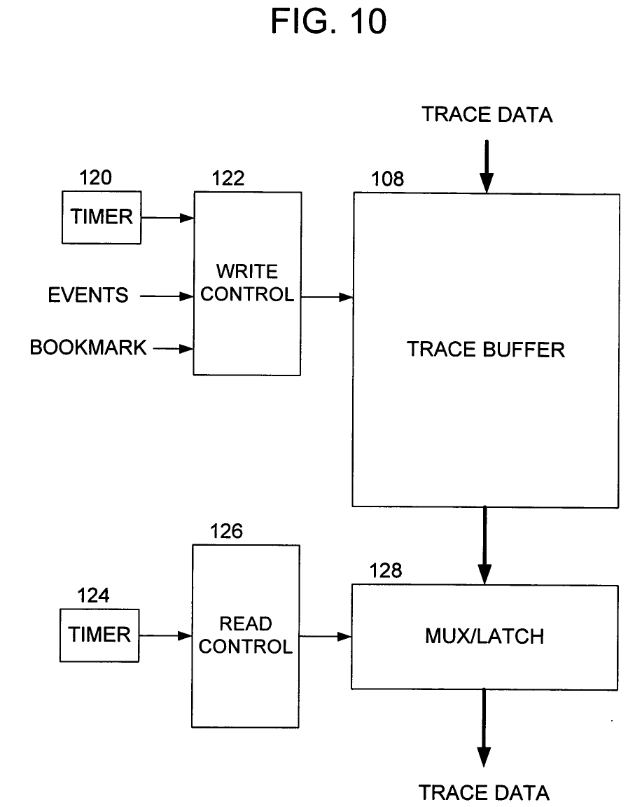

As discussed above, the data formatting and control circuit 106 is preferably operable to pack the trace data into the respective N-bit strings and store same in the trace buffer 108 either at prescribed time intervals or in response to a particular condition. In this regard, reference is now made to FIGS. 9-10. FIG. 9 is a conceptual diagram illustrating an example of trace data that may be stored in the trace buffer 108 in response to the supervisory program running on the main processor 102A. FIG. 10 is a block diagram illustrating an example implementation of the performance monitor 104.

The performance monitor 104, particularly the data formatting and control circuit 106, preferably includes a timer 120, a write control 122, a timer 124, a read control 126, and a multiplexer/latch circuit 128. The write control 122 is preferably operable to cause the trace data to be produced and stored in response to a timing signal from the timer 120, the occurrence of a particular event, such as the execution of a branch instruction, etc. by one of the processors 102A-D, and/or by the existence of bookmark data. The timer 120 is preferably operable to produce a signal indicating that the trace data should be produced and stored at particular time intervals, such as the aforementioned 16 processing cycles for some program address capturing, and 200 processing cycles for aggregate counts of program execution events. Preferably, the signaling into the write control 122 are prioritized such that the bookmark data is of the highest priority and is serviced ahead of any other signaling events indicating that trace data should be produced and written into the trace buffer 108. The read control circuit is preferably operable to cause the trace data to be extracted from the trace buffer 108 and output from the performance monitor 104 in response to a read timing signal from the timer 124.

As shown in FIG. 9, the write control 122 may cause bookmark data to be written into the trace buffer 108 during a time interval t0, 16-bit program addresses and aggregate counts to be stored in the trace buffer 108 at interval t1, a 64 bit program address to be stored in the trace buffer 108 at interval t2, etc. Preferably, the timers 120, 124 are programmable in response to the supervisory program such that the rate at which the trace data are stored in the trace buffer 108 and the rate at which the trace data are extracted from the trace buffer 108 are controlled to insure that the trace data are not overwritten within the trace buffer 108. Preferably, the trace buffer 108 is implemented as a first-in-first-out device.

As discussed above, the apparatus 100 preferably includes a data port through which the trace data may be removed from the trace buffer 108 for external storage and analysis. This data port may include a south bridge coupled between the trace buffer 108 and an external memory, such as a double data write (DDR) memory. Preferably, the data size on the DDR is configurable and the south bridge stops writing the extracted trace data into the DDR when the configured size is reached. In this regard, the south bridge preferably initiates an interrupt, which is sent back to the performance monitor 104 so that the read control 126 stops extracting trace data from the trace buffer 108. If this functionality is not supported, then the trace data will wrap around in the DDR and important trace data may be lost. In alternative configurations, a specialized south bridge may be employed that is capable of transmitting data at a GB rate to a special purpose DRAM, such as a YDRAM.

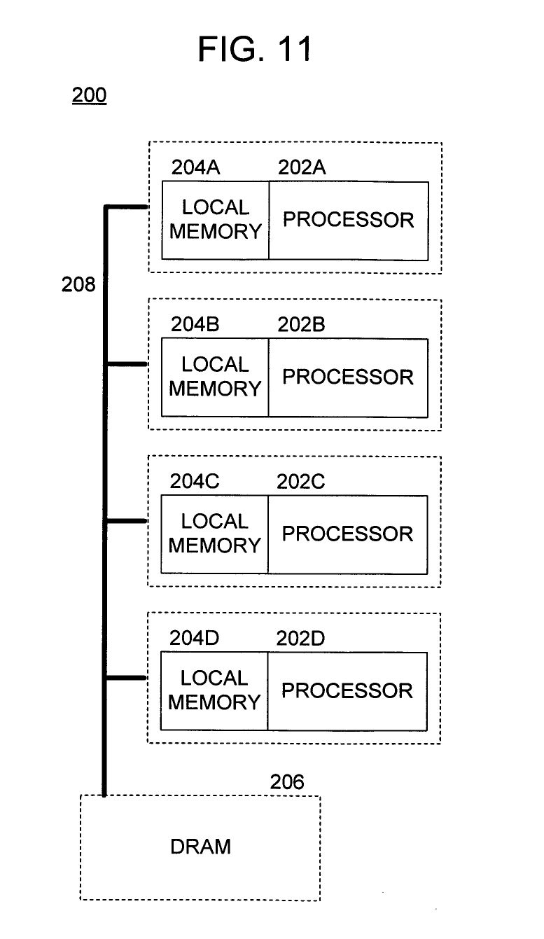

With reference to FIG. 11 and in accordance with a preferred embodiment of the invention, an alternative configuration of a computing apparatus 200 that is suitable for carrying out the aspects of the invention discussed above preferably includes a plurality of processors 202A-D, associated local memories 204A-D, and a main memory (or shared memory) 206 interconnected by way of a bus 208. Although four processors 202 are illustrated by way of example, any number may be utilized without departing from the spirit and scope of the present invention. Although not shown, the apparatus 200 also preferably includes the performance monitor 104 discussed above.

The processors 202 may be implemented utilizing any of the known technologies that are capable of requesting data from the system memory 206, and manipulating the data to achieve a desirable result. Notably, the local memory 204 is preferably located in the same chip as the respective processor 202; however, the local memory 204 is preferably not a hardware cache memory in that there are preferably no on chip or off chip hardware cache circuits, cache registers, cache memory controllers, etc. to implement a hardware cache memory function. In alternative embodiments, the local memory 204 may be a cache memory and/or an additional cache memory may be employed. As on chip space is often limited, the size of the local memory 204 may be much smaller than the system memory 206. The processors 202 preferably provides data access requests to copy data (which may include program data) from the system memory 206 over the bus 208 into the respective local memories 204 for program execution and data manipulation. The mechanism for facilitating data access may be implemented utilizing any of the known techniques, such as direct memory access (DMA) techniques.

A description of a preferred computer architecture for a multi-processor system will now be provided that is suitable for carrying out one or more of the features discussed herein. In accordance with one or more embodiments, the multi-processor system may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system must complete tasks in a short and predictable time.

To this end, and in accordance with this computer architecture, all processors of a multi-processing computer system are constructed from a common computing module (or cell). This common computing module has a consistent structure and preferably employs the same instruction set architecture. The multi-processing computer system can be formed of one or more clients, servers, PCs, mobile computers, game machines, PDAs, set top boxes, appliances, digital televisions and other devices using computer processors.

A plurality of the computer systems may also be members of a network if desired. The consistent modular structure enables efficient, high speed processing of applications and data by the multi-processing computer system, and if a network is employed, the rapid transmission of applications and data over the network. This structure also simplifies the building of members of the network of various sizes and processing power and the preparation of applications for processing by these members.

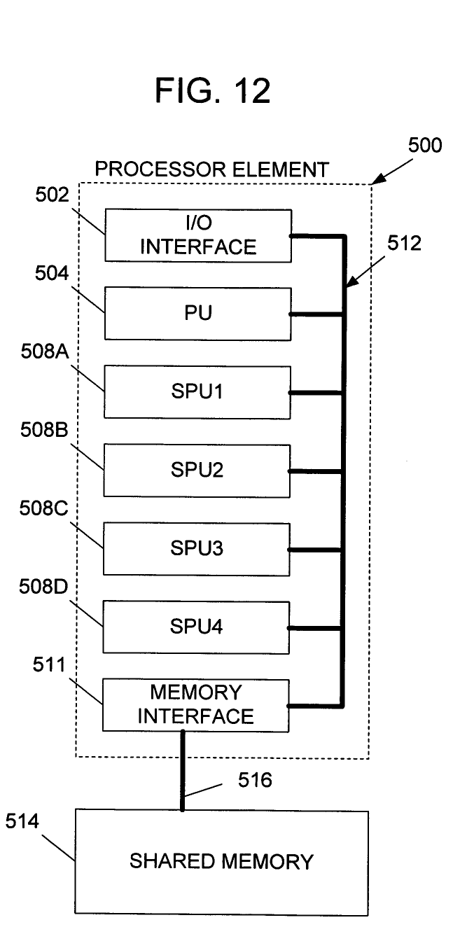

With reference to FIG. 12, the basic processing module is a processor element (PE) 500. The PE 500 comprises an I/O interface 502, a processing unit (PU) 504, and a plurality of sub-processing units 508, namely, sub-processing unit 508A, sub-processing unit 508B, sub-processing unit 508C, and sub-processing unit 508D. A local (or internal) PE bus 512 transmits data and applications among the PU 504, the sub-processing units 508, and a memory interface 511. The local PE bus 512 can have, e.g., a conventional architecture or can be implemented as a packet-switched network. If implemented as a packet switch network, while requiring more hardware, increases the available bandwidth.

The PE 500 can be constructed using various methods for implementing digital logic. The PE 500 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. The PE 500 also may be implemented using superconducting material, e.g., rapid single-flux-quantum (RSFQ) logic.

The PE 500 is closely associated with a shared (main) memory 514 through a high bandwidth memory connection 516. Although the memory 514 preferably is a dynamic random access memory (DRAM), the memory 514 could be implemented using other means, e.g., as a static random access memory (SRAM), a magnetic random access memory (MRAM), an optical memory, a holographic memory, etc.

The PU 504 and the sub-processing units 508 are preferably each coupled to a memory flow controller (MFC) including direct memory access DMA functionality, which in combination with the memory interface 511, facilitate the transfer of data between the DRAM 514 and the sub-processing units 508 and the PU 504 of the PE 500. It is noted that the DMAC and/or the memory interface 511 may be integrally or separately disposed with respect to the sub-processing units 508 and the PU 504. Indeed, the DMAC function and/or the memory interface 511 function may be integral with one or more (preferably all) of the sub-processing units 508 and the PU 504. It is also noted that the DRAM 514 may be integrally or separately disposed with respect to the PE 500. For example, the DRAM 514 may be disposed off-chip as is implied by the illustration shown or the DRAM 514 may be disposed on-chip in an integrated fashion.

The PU 504 can be, e.g., a standard processor capable of stand-alone processing of data and applications. In operation, the PU 504 preferably schedules and orchestrates the processing of data and applications by the sub-processing units. The sub-processing units preferably are single instruction, multiple data (SIMD) processors. Under the control of the PU 504, the sub-processing units perform the processing of these data and applications in a parallel and independent manner. The PU 504 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PU 504 may be implemented by one of the sub-processing units 508 taking on the role of a main processing unit that schedules and orchestrates the processing of data and applications by the sub-processing units 508. Further, there may be more than one PU implemented within the processor element 500.

In accordance with this modular structure, the number of PEs 500 employed by a particular computer system is based upon the processing power required by that system. For example, a server may employ four PEs 500, a workstation may employ two PEs 500 and a PDA may employ one PE 500. The number of sub-processing units of a PE 500 assigned to processing a particular software cell depends upon the complexity and magnitude of the programs and data within the cell.

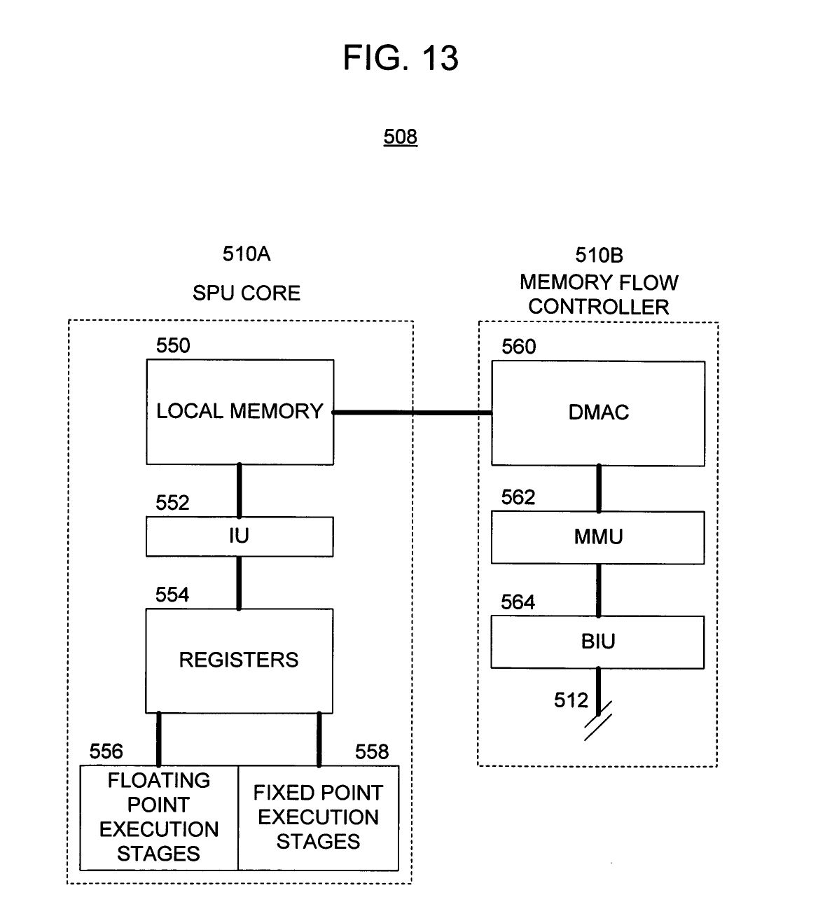

FIG. 13 illustrates the preferred structure and function of a sub-processing unit (SPU) 508. The SPU 508 architecture preferably fills a void between general-purpose processors (which are designed to achieve high average performance on a broad set of applications) and special-purpose processors (which are designed to achieve high performance on a single application). The SPU 508 is designed to achieve high performance on game applications, media applications, broadband systems, etc., and to provide a high degree of control to programmers of real-time applications. Some capabilities of the SPU 508 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The sub-processing unit 508 includes two basic functional units, namely an SPU core 510A and a memory flow controller (MFC) 510B. The SPU core 510A performs program execution, data manipulation, etc., while the MFC 510B performs functions related to data transfers between the SPU core 510A and the DRAM 514 of the system.

The SPU core 510A includes a local memory 550, an instruction unit (IU) 552, registers 554, one ore more floating point execution stages 556 and one or more fixed point execution stages 558. The local memory 550 is preferably implemented using single-ported random access memory, such as an SRAM. Whereas most processors reduce latency to memory by employing caches, the SPU core 510A implements the relatively small local memory 550 rather than a cache. Indeed, in order to provide consistent and predictable memory access latency for programmers of real-time applications (and other applications as mentioned herein) a cache memory architecture within the SPU 508A is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 550 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the sub-processing units 508 references the associated local memory 550 using a local address, however, each location of the local memory 550 is also assigned a real address (RA) within the overall system's memory map. This allows Privilege Software to map a local memory 550 into the Effective Address (EA) of a process to facilitate DMA transfers between one local memory 550 and another local memory 550. The PU 504 can also directly access the local memory 550 using an effective address. In a preferred embodiment, the local memory 550 contains 556 kilobytes of storage, and the capacity of registers 552 is 128×128 bits.

The SPU core 504A is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 552 includes an instruction buffer, instruction decode circuitry, dependency check circuitry, and instruction issue circuitry.

The instruction buffer preferably includes a plurality of registers that are coupled to the local memory 550 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 550, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decoder circuitry 112 simultaneously.

The instruction issue circuitry is operable to issue the instructions to the floating point execution stages 556 and/or the fixed point execution stages 558.

The registers 554 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU core 510A is of a superscalar architecture, such that more than one instruction is issued per clock cycle. The SPU core 510A preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 556 and fixed point execution stages 558 may be employed. In a preferred embodiment, the floating point execution stages 556 operate at a speed of 32 billion floating point operations per second (32 GFLOPS), and the fixed point execution stages 558 operate at a speed of 32 billion operations per second (32 GOPS).

The MFC 510B preferably includes a bus interface unit (BIU) 564, a memory management unit (MMU) 562, and a direct memory access controller (DMAC) 560. With the exception of the DMAC 560, the MFC 510B preferably runs at half frequency (half speed) as compared with the SPU core 510A and the bus 512 to meet low power dissipation design objectives. The MFC 510B is operable to handle data and instructions coming into the SPU 508 from the bus 512, provides address translation for the DMAC, and snoop-operations for data coherency. The BIU 564 provides an interface between the bus 512 and the MMU 562 and DMAC 560. Thus, the SPU 508 (including the SPU core 510A and the MFC 510B) and the DMAC 560 are connected physically and/or logically to the bus 512.

The MMU 562 is preferably operable to translate effective addresses (taken from DMA commands) into real addresses for memory access. For example, the MMU 562 may translate the higher order bits of the effective address into real address bits. The lower-order address bits, however, are preferably untranslatable and are considered both logical and physical for use to form the real address and request access to memory. In one or more embodiments, the MMU 562 may be implemented based on a 64-bit memory management model, and may provide 264 bytes of effective address space with 4K-, 64K-, 1M-, and 16M-byte page sizes and 256 MB segment sizes. Preferably, the MMU 562 is operable to support up to 265 bytes of virtual memory, and 2 bytes (4 TeraBytes) of physical memory for DMA commands. The hardware of the MMU 562 may include an 8-entry, fully associative SLB, a 256-entry, 4way set associative TLB, and a 4×4 Replacement Management Table (RMT) for the TLB—used for hardware TLB miss handling.

The DMAC 560 is preferably operable to manage DMA commands from the SPU core 510A and one or more other devices such as the PU 504 and/or the other SPUs. There may be three categories of DMA commands: Put commands, which operate to move data from the local memory 550 to the shared memory 514; Get commands, which operate to move data into the local memory 550 from the shared memory 514; and Storage Control commands, which include SLI commands and synchronization commands. The synchronization commands may include atomic commands, send signal commands, and dedicated barrier commands. In response to DMA commands, the MMU 562 translates the effective address into a real address and the real address is forwarded to the BIU 564.

The SPU core 510A preferably uses a channel interface and data interface to communicate (send DMA commands, status, etc.) with an interface within the DMAC 560. The SPU core 510A dispatches DMA commands through the channel interface to a DMA queue in the DMAC 560. Once a DMA command is in the DMA queue, it is handled by issue and completion logic within the DMAC 560. When all bus transactions for a DMA command are finished, a completion signal is sent back to the SPU core 510A over the channel interface.

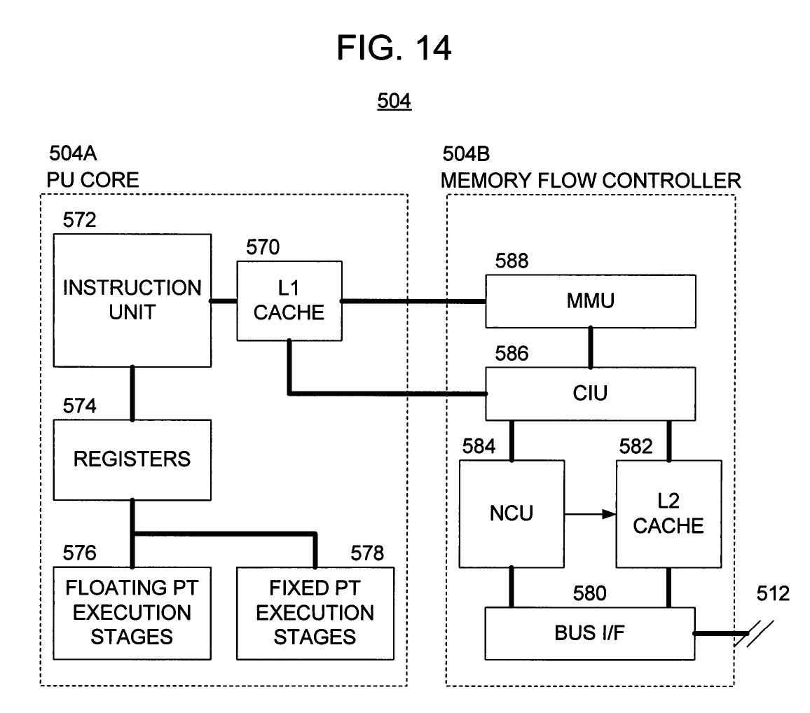

FIG. 14 illustrates the preferred structure and function of the PU 504. The PU 504 includes two basic functional units, the PU core 504A and the memory flow controller (MFC) 504B. The PU core 504A performs program execution, data manipulation, multi-processor management functions, etc., while the MFC 504B performs functions related to data transfers between the PU core 504A and the memory space of the system 100.

The PU core 504A may include an L1 cache 570, an instruction unit 572, registers 574, one or more floating point execution stages 576 and one or more fixed point execution stages 578. The L1 cache provides data caching functionality for data received from the shared memory 106, the processors 102, or other portions of the memory space through the MFC 504B. As the PU core 504A is preferably implemented as a superpipeline, the instruction unit 572 is preferably implemented as an instruction pipeline with many stages, including fetching, decoding, dependency checking, issuing, etc. The PU core 504A is also preferably of a superscalar configuration, whereby more than one instruction is issued from the instruction unit 572 per clock cycle. To achieve a high processing power, the floating point execution stages 576 and the fixed point execution stages 578 include a plurality of stages in a pipeline configuration. Depending upon the required processing power, a greater or lesser number of floating point execution stages 576 and fixed point execution stages 578 may be employed.

The MFC 504B includes a bus interface unit (BIU) 580, an L2 cache memory, a non-cachable unit (NCU) 584, a core interface unit (CIU) 586, and a memory management unit (MMU) 588. Most of the MFC 504B runs at half frequency (half speed) as compared with the PU core 504A and the bus 108 to meet low power dissipation design objectives.

The BIU 580 provides an interface between the bus 108 and the L2 cache 582 and NCU 584 logic blocks. To this end, the BIU 580 may act as a Master as well as a Slave device on the bus 108 in order to perform fully coherent memory operations. As a Master device it may source load/store requests to the bus 108 for service on behalf of the L2 cache 582 and the NCU 584. The BIU 580 may also implement a flow control mechanism for commands which limits the total number of commands that can be sent to the bus 108. The data operations on the bus 108 may be designed to take eight beats and, therefore, the BIU 580 is preferably designed around 128 byte cache-lines and the coherency and synchronization granularity is 128 KB.

The L2 cache memory 582 (and supporting hardware logic) is preferably designed to cache 512 KB of data. For example, the L2 cache 582 may handle cacheable loads/stores, data pre-fetches, instruction fetches, instruction pre-fetches, cache operations, and barrier operations. The L2 cache 582 is preferably an 8-way set associative system. The L2 cache 582 may include six reload queues matching six (6) castout queues (e.g., six RC machines), and eight (64-byte wide) store queues. The L2 cache 582 may operate to provide a backup copy of some or all of the data in the L1 cache 570. Advantageously, this is useful in restoring state(s) when processing nodes are hot-swapped. This configuration also permits the L1 cache 570 to operate more quickly with fewer ports, and permits faster cache-to-cache transfers (because the requests may stop at the L2 cache 582). This configuration also provides a mechanism for passing cache coherency management to the L2 cache memory 582.

The NCU 584 interfaces with the CIU 586, the L2 cache memory 582, and the BIU 580 and generally functions as a queueing/buffering circuit for non-cacheable operations between the PU core 504A and the memory system. The NCU 584 preferably handles all communications with the PU core 504A that are not handled by the L2 cache 582, such as cache-inhibited load/stores, barrier operations, and cache coherency operations. The NCU 584 is preferably run at half speed to meet the aforementioned power dissipation objectives.

The CIU 586 is disposed on the boundary of the MFC 504B and the PU core 504A and acts as a routing, arbitration, and flow control point for requests coming from the execution stages 576, 578, the instruction unit 572, and the MMU unit 588 and going to the L2 cache 582 and the NCU 584. The PU core 504A and the MMU 588 preferably run at full speed, while the L2 cache 582 and the NCU 584 are operable for a 2:1 speed ratio. Thus, a frequency boundary exists in the CIU 586 and one of its functions is to properly handle the frequency crossing as it forwards requests and reloads data between the two frequency domains.

The CIU 586 is comprised of three functional blocks: a load unit, a store unit, and reload unit. In addition, a data pre-fetch function is performed by the CIU 586 and is preferably a functional part of the load unit. The CIU 586 is preferably operable to: (i) accept load and store requests from the PU core 504A and the MMU 588; (ii) convert the requests from full speed clock frequency to half speed (a 2:1 clock frequency conversion); (iii) route cachable requests to the L2 cache 582, and route non-cachable requests to the NCU 584; (iv) arbitrate fairly between the requests to the L2 cache 582 and the NCU 584; (v) provide flow control over the dispatch to the L2 cache 582 and the NCU 584 so that the requests are received in a target window and overflow is avoided; (vi) accept load return data and route it to the execution stages 576, 578, the instruction unit 572, or the MMU 588; (vii) pass snoop requests to the execution stages 576, 578, the instruction unit 572, or the MMU 588; and (viii) convert load return data and snoop traffic from half speed to full speed.

The MMU 588 preferably provides address translation for the PU core 540A, such as by way of a second level address translation facility. A first level of translation is preferably provided in the PU core 504A by separate instruction and data ERAT (effective to real address translation) arrays that may be much smaller and faster than the MMU 588.

In a preferred embodiment, the PU 504 operates at 4-6 GHz, 10F04, with a 64-bit implementation. The registers are preferably 64 bits long (although one or more special purpose registers may be smaller) and effective addresses are 64 bits long. The instruction unit 570, registers 572 and execution stages 574 and 576 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus, comprising:
a plurality of processors, each operable to execute software by addressing instructions in accordance with addresses obtained from a program counter; and
a performance monitor circuit operable to produce and store trace data from program status data received from the processors, the trace data including: (i) aggregate counts of respective program execution events; (ii) the addresses obtained from the program counter at various times; and (iii) bookmark data containing program performance information that includes neither the aggregate counts nor the addresses.

2. The apparatus of claim 1, wherein the performance monitor circuit includes a trace buffer in which to store the trace data.

3. The apparatus of claim 1, wherein the processors and the performance monitor circuit are disposed within a common integrated circuit.

4. The apparatus of claim 3, wherein the integrated circuit includes a data port through which the trace data may be extracted from the trace buffer.

5. The apparatus of claim 1, wherein the trace data are produced and stored at regular time intervals.

6. The apparatus of claim 5, wherein the aggregate counts of respective program execution events are produced and stored at regular time intervals.

7. The apparatus of claim 5, wherein the addresses obtained from the program counter are stored at regular time intervals.

8. The apparatus of claim 5, wherein the bookmark data are not produced and stored at regular time intervals.

9. The apparatus of claim 1, wherein at least one of:
the program execution events include at least one of a cache miss event, execution of a particular software instruction, and a program stall;
the particular software instruction is a load instruction;
the program stall includes at least one of a branch miss stall and a direct memory access stall; and
the bookmark data includes at least one of program thread information.

10. The apparatus of claim 1, wherein the performance monitor circuit includes:
at least one multiplexer operable to receive respective signals from the processors indicative of the occurrences of the program execution events; and
at least one digital counter operable to receive an output from the multiplexer and to produce the aggregate counts of the respective program execution events.

11. The apparatus of claim 10, further comprising at least one of the multiplexers and counters associated with each processor.

12. The apparatus of claim 1, wherein the performance monitor circuit is operable to pack the aggregate counts, the addresses, and the bookmark data into respective strings of N bits in length and to store same in a trace buffer.

13. The apparatus of claim 12, wherein the performance monitor circuit is operable to pack at least some of the aggregate counts and at least some of the addresses in the same string.

14. The apparatus of claim 12, wherein the performance monitor circuit is operable to pack the bookmark data in separate strings from the aggregate counts and the addresses.

15. The apparatus of claim 1, wherein the performance monitor circuit is operable to pack the aggregate counts, the addresses, and the bookmark data into respective strings in accordance with a priority assigned to each type of trace data, the priority of the bookmark data being of a higher priority than the other types of trace data.

16. An apparatus, comprising:
at least one processor operable to execute software by addressing instructions in accordance with addresses obtained from a program counter; and
a performance monitor circuit operable to produce and store trace data from program status data received from the at least one processor, the trace data including: (i) aggregate counts of respective program execution events; (ii) the addresses obtained from the program counter at various times; and (iii) bookmark data containing program performance information that includes neither the aggregate counts nor the addresses.

17. An apparatus, comprising:
a plurality of processors, each operable to execute software by addressing instructions in accordance with addresses obtained from a first program counter;
a main processing unit operable to execute software by addressing instructions in accordance with addresses obtained from a second program counter; and
a performance monitor circuit operable to produce and store trace data from program status data received from the processors, the trace data including: (i) aggregate counts of respective program execution events; (ii) the addresses obtained from at least one of the first and second program counters at various times; and (iii) bookmark data containing program performance information that includes neither the aggregate counts nor the addresses,
wherein the main processing unit is further operable to execute a supervisory software program that causes at least one of the aggregate counts, the addresses, and the bookmark data to be introduced into the trace data when one or more conditions are met.

18. The apparatus of claim 17, wherein the one or more conditions include that at least one of the following assembly language instructions occurs: (i) bclr(l) w/taken; (ii) bcctr(l) w/taken; (iii) rfid.

19. The apparatus of claim 17, wherein the performance monitor circuit is operable to pack the aggregate counts, the addresses, and the bookmark data into respective strings of N bits in length and to store same in a trace buffer.

20. The apparatus of claim 17, wherein the performance monitor circuit is operable to pack at least some of the aggregate counts and at least some of the addresses in the same string.

21. The apparatus of claim 17, wherein the performance monitor circuit is operable to pack the bookmark data in separate strings from the aggregate counts and the addresses.

22. The apparatus of claim 17, wherein the performance monitor circuit is operable to pack the addresses from one or more of the processors in the same string.

23. The apparatus of claim 17, wherein the performance monitor circuit is operable to pack the addresses from the main processor in separate strings from the aggregate counts, the addresses from one or more of the processors, the addresses from the main processor, and the bookmark data.

24. A performance monitor, comprising:
a formatting circuit operable to produce trace data from program status data received from at least one processor, the at least one processor being operable to execute software by addressing instructions in accordance with addresses obtained from a program counter;
a trace buffer operable to store the trace data; and
a controller operable to manage the writing of the trace data into the trace buffer and the reading of the trace data out of the trace buffer,
wherein the trace data includes: (i) aggregate counts of respective program execution events; (ii) the addresses obtained from the program counter at various times; and (iii) bookmark data containing program performance information that includes neither the aggregate counts nor the addresses.

25. The apparatus of claim 24, wherein the controller is operable such that at least one of:
the trace data are produced and stored at regular time intervals;
the aggregate counts of respective program execution events are produced and stored at regular time intervals;
the addresses obtained from the program counter are stored at regular time intervals; and
the bookmark data are not produced and stored at regular time intervals.

26. The apparatus of claim 25, wherein the controller includes a write control circuit operable to cause the trace data to be produced and stored in response to a timing signal.

27. The apparatus of claim 26, wherein the timing signal is programmable such that time intervals at which at least some of the trace data are produced and stored may be controlled.

28. The apparatus of claim 25, wherein the controller includes a read control circuit operable to cause the trace data to be extracted from the trace buffer and output from the performance monitor in response to a timing signal.

29. The apparatus of claim 28, wherein the timing signal is programmable such that time intervals at which the trace data are extracted from the trace buffer may be controlled.

30. The apparatus of claim 25, wherein the controller includes:
a write control circuit operable to cause the trace data to be produced and stored in response to a write timing signal; and
a read control circuit operable to cause the trace data to be extracted from the trace buffer and output from the performance monitor in response to a read timing signal,
wherein the controller is operable to monitor an amount of trace data within the trace buffer and manipulate the write control circuit to ensure that the trace data are not overwritten.

31. A method, comprising:
producing trace data from program status data received from at least one processor, the at least one processor being operable to execute software by addressing instructions in accordance with addresses obtained from a program counter; and
storing the trace data in a trace buffer,
wherein the trace data includes: (i) aggregate counts of respective program execution events; (ii) the addresses obtained from the program counter at various times; and (iii) bookmark data containing program performance information that includes neither the aggregate counts nor the addresses.

32. The method of claim 31, further comprising producing and storing the trace data at regular time intervals.

33. The method of claim 32, further comprising producing and storing the aggregate counts of respective program execution events at regular time intervals.

34. The method of claim 32, further comprising obtaining and storing the addresses from the program counter at regular time intervals.

35. The method of claim 32, wherein the bookmark data are not produced and stored at regular time intervals.

36. The method of claim 31, wherein at least one of:
the program execution events include at least one of a cache miss event, execution of a particular software instruction, and a program stall;
the particular software instruction is a load instruction;
the program stall includes at least one of a branch miss stall and a direct memory access stall; and
the bookmark data includes at least one of program thread information.

37. The method of claim 31, further comprising:
receiving respective signals from the processors indicative of the occurrences of the program execution events; and
counting the respective program execution events to produce the aggregate counts.

38. The method of claim 31, further comprising packing the aggregate counts, the addresses, and the bookmark data into respective strings of N bits in length for storage in the trace buffer.

39. The method of claim 38, further comprising packing at least some of the aggregate counts and at least some of the addresses in the same string.

40. The method of claim 38, further comprising packing the bookmark data in separate strings from the aggregate counts and the addresses.

41. The method of claim 31, further comprising packing the aggregate counts, the addresses, and the bookmark data into respective strings in accordance with a priority assigned to each type of trace data, the priority of the bookmark data being of a higher priority than the other types of trace data.

42. The method of claim 31, further comprising:
monitoring an amount of trace data within the trace buffer; and
adjusting a rate at which the trace data are written into the trace buffer and a rate at which the trace data are read from the trace buffer to ensure that the trace data are not overwritten.

43. A storage medium containing a software program capable of causing a processor system to execute actions, comprising:
producing trace data from program status data received from at least one processor, the at least one processor being operable to execute software by addressing instructions in accordance with addresses obtained from a program counter; and
storing the trace data in a trace buffer,
wherein the trace data includes: (i) aggregate counts of respective program execution events; (ii) the addresses obtained from the program counter at various times; and (iii) bookmark data containing program performance information that includes neither the aggregate counts nor the addresses.

44. The storage medium of claim 43, further comprising:
receiving respective signals from the processors indicative of the occurrences of the program execution events; and
counting the respective program execution events to produce the aggregate counts.

45. The storage medium of claim 44, further comprising packing the aggregate counts, the addresses, and the bookmark data into respective strings of N bits in length for storage in the trace buffer.

46. The storage medium of claim 45, further comprising packing at least some of the aggregate counts and at least some of the addresses in the same string.

47. The storage medium of claim 46, further comprising packing the bookmark data in separate strings from the aggregate counts and the addresses.

48. The storage medium of claim 43, further comprising packing the aggregate counts, the addresses, and the bookmark data into respective strings in accordance with a priority assigned to each type of trace data, the priority of the bookmark data being of a higher priority than the other types of trace data.

49. The storage medium of claim 43, further comprising:
monitoring an amount of trace data within the trace buffer; and
adjusting a rate at which the trace data are written into the trace buffer and a rate at which the trace data are read from the trace buffer to ensure that the trace data are not overwritten.
